(19) United States
(12) Patent Application Publication
(10) Pub. No.: US 2011/0244441 A1
(43) Pub. Date: Oct. 6, 2011

(54) HELP DISPLAY DEVICE, OPERATION DEVICE AND ELECTRONIC APPARATUS

(75) Inventors: Yoshifumi Okabayashi, Osaka (JP); Satoshi Kawakami, Osaka (JP)

(73) Assignee: KYOCERA MITA CORPORATION, OSAKA (JP)

(21) Appl. No.: 13/075,928

(22) Filed: Mar. 30, 2011

(30) Foreign Application Priority Data
Apr. 2, 2010 (JP) 2010-085738
Apr. 2, 2010 (JP) 2010-085739

(51) Int. Cl. G09B 19/00

(52) U.S. Cl. 434/365

(57) ABSTRACT

A help display device of the present invention includes: a display portion that displays a help message; an operation portion that accepts an instruction for displaying a predetermined help message; a message storage portion that stores identical help messages expressed in a plurality of languages; a display order retention portion that retains a display order of the help messages expressed in a plurality of languages; a message generation portion that, in a case where the operation portion accepts the instruction for displaying a help message on the display, reads the help message corresponding to the instruction from the message storage portion and generates a multilingual help message by arranging the help messages of each language thus read in the display order retained in the display order retention portion; and a display control portion that displays the multilingual help message on the display portion by the message generation portion.

This application is based on and claims the benefit of priority from Japanese Patent Application Nos. 2010-085738 and 2010-085739, respectively filed on 2 Apr. 2010 and 2 Apr. 2010, the contents of which are incorporated herein by reference.

### BACKGROUND OF THE INVENTION

1. Field of the Invention

The present invention relates to a help display device that displays a help message, and an operation device and an electronic apparatus provided with a help function.

2. Related Art

Recently, multi-functional peripherals (MFP) having functions of scanner, facsimile machine, printer, copy machine and the like are used in offices and the like. Such multi-functional peripherals are often used in a state of being connected to an information processing terminal such as a personal computer via a network such as LAN (Local Area Network). The multi-functional peripherals function as: an image forming apparatus that prints image data being input from the image processing terminal on paper; an image reading apparatus that obtains image data used in the image processing terminal; and a document management apparatus that accumulates document image data so as to be searchable.

In such multi-functional peripherals having various functions, a help function that displays help messages introducing and describing usage and operation method of each functions in response to a user's request is provided as it is difficult for a user to understand usage and operation method of all functions. In addition, various techniques are proposed for improving convenience of such a help function.

For example, an image forming apparatus is disclosed that automatically displays a help guidance screen and a help menu screen if a user is determined, as a result of detection of contraction of facial muscle thereof, to be confused. In addition, an image forming apparatus is disclosed that has a function of extending a display period of help information and can change a display mode of the help information according to knowledge level of a user. An image forming apparatus that determines confusion of a user and automatically displays a help screen if the user performs irrelative operations for a predetermined number of times is also disclosed.

Image forming apparatuses are sold not only domestically but also in foreign countries. For that reason, many of the image forming apparatuses have a function allowing selection of a language displayed on an operation screen (hereinafter referred to as “display language”) from a plurality of languages. The display language is set to a predetermined language (hereinafter referred to as “default display language”) per apparatus basis, by, for example, an apparatus manager operating a system menu.

The display language of an image forming apparatus can be set according to a shipping destination and a sales destination thereof. Since it was not often that an image forming apparatus once-shipped was moved to another language region, there was not much need for changing the display language. Therefore, the system menu for switching the display language has been often located deep in a menu structure or configured not to be operable by a general user.

Incidentally, multinational and global companies increase in number in which users who speak different native languages work in the same office. In such an office, the users who speak different native languages use the same image forming apparatus.

Even users who speak foreign native languages generally have knowledge of an official language of the office, to such a degree that they can understand a menu screen of the image forming apparatus. Therefore, the default display language of the image forming apparatus is generally set to the official language of the office.

In such a situation, for example in a case where a user changes the display language to a foreign language by accessing a system menu and leaves without setting the display language back to the default display language, the operation screen continues to display the foreign language.

This gives trouble to other users not knowing how to access the system menu.

In view of such a situation, an image forming apparatus has been proposed in which the display language can be easily switched.

This image forming apparatus provides a language selection means in a standby screen for each of functions: a scanner function; a copy function; a printer function; a facsimile function; and the like, that allows selection of the display language individually for each function.

A user whose native language is different from the display language also refers to help messages in a case of using an unfamiliar function. However, if a function is unknown or not familiar to the user, help messages thereof are often difficult for the user to understand. In other words, help messages in the default display language is not easily understood by a user whose mother tongue is different therefrom.

As described above, to switch the display language, it is necessary to operate a system menu that the user generally does not use. Therefore, the user must refer to a help message in a language that is different from their native language. In order to switch the default display language to a desired language, a complex procedure is required.

To address such a problem, a configuration can be employed in which, even in a case where a default display language is set for an image forming apparatus, the identical help messages in other languages than the default display language are also displayed. In such a configuration, a user can refer to a help message expressed in a language he/she is familiar with and easily understand the help message, without switching the display language.

However, since recent image forming apparatuses allow selection of 5 or 6 languages for the display language, it is difficult to display help messages in all available languages simultaneously within a single display screen. Accordingly, to display the identical help messages in languages other than the default display language along with the help message in the default display language, the help messages of these languages must be displayed on the display screen in a predetermined sequence.

By preregistering a multilingual help message including help messages expressed in a plurality of languages, the help messages in these languages can be displayed on the display screen in sequence. In this case, a display order of the help messages in these languages is fixed regardless of the default display language being configured for the image forming apparatus. As a result, the help message in the default display language may be in a lower position in the display order.

Alternatively, a configuration can be employed in which a plurality of multilingual help messages are preregistered in which one of display languages comes first followed by others in a predetermined order, and one of the plurality of multilingual help messages, in which the default display language comes first, is selected; however, display order is fixed except for the default display language and the help message in a language preferred by a user may still be in a lower position in the display order when the language preferred by a user is not the default display language. Such a situation is extremely inefficient. In addition, in such a configuration, in a case of adding a language, which is not provided in the image forming apparatus, to the display languages afterward, update of the multilingual help messages is required.

Furthermore, in recent multifunctional image forming apparatuses, the amount of information to be displayed on the display screen of an operation panel is dramatically increased, and therefore it is not desirable to provide a display region that always displays a language switching button in the display screen.

Alternatively, it is possible to configure to display a screen including a language switching button the operation screen by operating the operation screen; however, this requires a special operation by a user and is cumbersome.

### SUMMARY OF THE INVENTION

An objective of the present invention is to provide a help display device and an electronic apparatus that can efficiently display a multilingual help message expressed in a plurality of languages according to a user's needs.

In order to achieve the abovementioned objective, the present invention provides a help display device including:

a display portion that displays a help message;

an operation portion that accepts an instruction for displaying a predetermined help message;

a message storage portion that stores identical help messages expressed in a plurality of languages;

a display order retention portion that retains a display order of the help messages expressed in a plurality of languages;

a message generation portion that, in a case where the operation portion accepts the instruction for displaying a help message on the display, reads the help message corresponding to the instruction from the message storage portion and generates a multilingual help message by arranging the help messages of each language thus read in the display order retained in the display order retention portion; and

a display control portion that displays the multilingual help message on the display portion by the message generation portion, and an electronic apparatus including the help display device.

Another objective of the present invention is to provide an operation device and an electronic apparatus in which a user whose native language is different from the display language can easily refer to and understand a help message and can then smoothly operate the electronic apparatus.

In order to achieve the abovementioned objective, the present invention provides an operation device including:

a display portion;

an operation portion that accepts an instruction for displaying a predetermined help message;

a message storage portion that stores identical help messages expressed in a plurality of languages;

a display control portion that performs display in a predetermined display language and displays the help messages expressed in a plurality of languages on the display portion;

a language detection portion that detects the language of the help message referred to by a user in the help message expressed in a plurality of languages; and

a language switching portion that switches the display language displayed on the display portion to the language detected by the language detection portion and switches the display language displayed on the display portion from the language detected by the language detection portion to the predetermined display language if a preregistered display language switching termination condition is satisfied, and

an electronic apparatus including the operation device.

### BRIEF DESCRIPTION OF THE DRAWINGS

FIG. 1 is a schematic configuration diagram showing an overall configuration of a multi-function peripheral according to a first embodiment of the present invention;

FIG. 2 is a schematic view showing an operation panel of the multi-function peripheral according to the first embodiment of the present invention;

FIG. 3 is a diagram showing a hardware configuration of the multi-function peripheral according to the first embodiment of the present invention;

FIG. 4 is a function block diagram showing the multi-function peripheral according to the first embodiment of the present invention;

FIG. 5 is a flow diagram showing an example of a multilingual help message display procedure executed by the multi-function peripheral according to the first embodiment of the present invention;

FIG. 6 is a diagram showing an example of a configuration screen shown in the multi-function peripheral according to the first embodiment of the present invention;

FIG. 7 is a diagram showing an example of a language display order table retained by the multi-function peripheral according to the first embodiment of the present invention;

FIG. 8 is a diagram showing an example of a multilingual help message displayed by the multi-function peripheral according to the first embodiment of the present invention;

FIG. 9A is a diagram showing an example of a state in which the multi-function peripheral according to the first embodiment of the present invention displays a help message;

FIG. 9B is a diagram showing an example of a state in which the multi-function peripheral according to the first embodiment of the present invention displays a help message;

FIG. 10 is a diagram showing an example of a referred frequency table retained by the multi-function peripheral according to the first embodiment of the present invention;

FIG. 11 is a diagram showing an example of a referred frequency table retained by the multi-function peripheral according to the first embodiment of the present invention;

FIG. 12 is a diagram showing an example of a language display order table retained by the multi-function peripheral according to the first embodiment of the present invention;

FIG. 13 is a diagram showing an example of a multilingual help message displayed by the multi-function peripheral according to the first embodiment of the present invention;

FIG. 14 is a diagram showing an example of a referred frequency table retained by the multi-function peripheral according to the first embodiment of the present invention;

FIG. 15 is a diagram showing an example of a language display order table retained by the multi-function peripheral according to the first embodiment of the present invention;

FIG. 16 is a diagram showing an example of a multilingual help message displayed by the multi-function peripheral according to the first embodiment of the present invention;

FIG. 17 is a function block diagram showing the multi-function peripheral according to a second embodiment of the present invention;

FIG. 18 is a flow diagram showing an example of a language switching procedure executed by the multi-function peripheral according to the second embodiment of the present invention;

FIG. 19 is a diagram showing an example of a configuration screen shown in the multi-function peripheral according to the second embodiment of the present invention;

FIG. 20 is a diagram showing an example of a help message displayed by the multi-function peripheral according to the second embodiment of the present invention;

FIG. 21A is a diagram showing an example of a state in which the multi-function peripheral according to the second embodiment of the present invention displays a help message;

FIG. 21B is a diagram showing an example of a state in which the multi-function peripheral according to the second embodiment of the present invention displays a help message;

FIG. 22 is a diagram showing an example of a configuration screen in a display language switching mode, shown in the multi-function peripheral according to the second embodiment of the present invention; and

FIG. 23 is a diagram showing an operation panel in the display language switching mode, of the multi-function peripheral according to the second embodiment of the present invention.

### DETAILED DESCRIPTION OF THE INVENTION

Embodiments of the present invention are described in detail hereinafter with reference to the drawings. A digital multi-function peripheral is described hereinafter as a concrete example of the present invention.

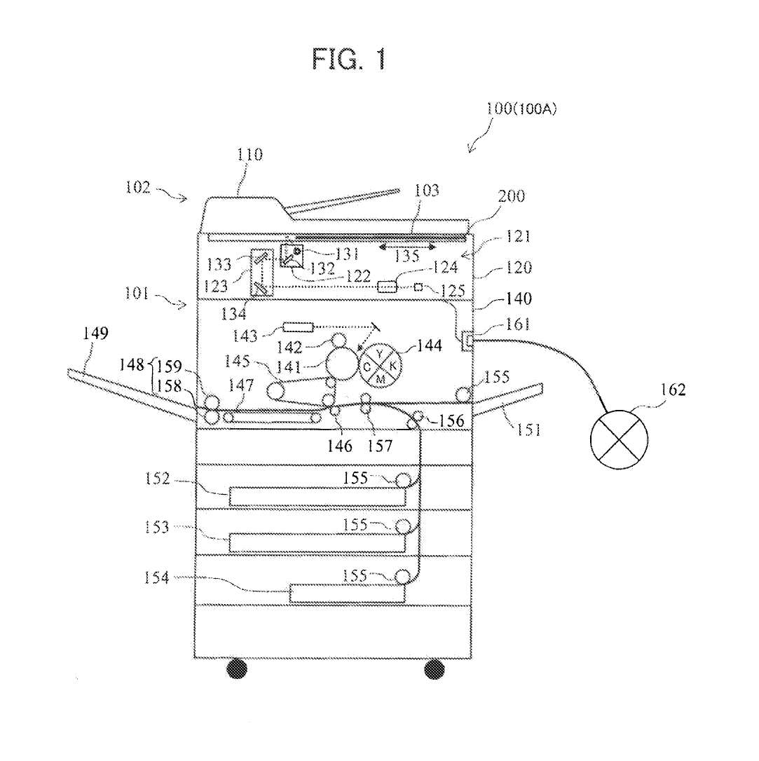

First, a first embodiment of the present invention is described with reference to FIGS. 1 to 16.

FIG. 1 is a schematic configuration diagram showing an example of an overall configuration of a multi-function peripheral according to the first embodiment. As shown in FIG. 1, a multi-function peripheral 100 is provided with: a main body 101 including an image reading portion 120 and an image forming portion 140; and a platen cover 102 attached to an upper side of the main body 101. A platen 103 is provided on an upper face of the main body 101, the platen 103 being opened and closed by the platen cover 102. The platen cover 102 is provided with a original feeder 110.

The image reading portion 120 is provided below the platen 103. The image reading portion 120 reads an image of a original by means of a scanning optical system 121 and generates digital data of the image thus read.

The original is placed on the platen 103 or the original feeder 110.

The scanning optical system 121 is provided with a first carriage 122, a second carriage 123, and a condensing lens 124.

The first carriage 122 includes a linear light source 131 and a mirror 132.

The second carriage 123 includes mirrors 133 and 134.

The light source 131 illuminates the original.

The mirrors 132, 133 and 134 guide reflected light from the original to the condensing lens 124.

The condensing lens 124 forms an optical image on an acceptance surface of a line image sensor 125.

In the scanning optical system 121, the first carriage 122 and the second carriage 123 are provided so as to be reciprocatable in a sub-scanning direction 135. By moving the first carriage 122 and the second carriage 123 in the sub-scanning direction 135, the image sensor 125 can scan an entire image of the original placed on the platen 103.

In a case of scanning an image of the original placed on the original feeder 110, the image reading portion 120 temporarily fixes the first carriage 122 and the second carriage 123 at an image reading position, and then the image sensor 125 scans an image of the original passing through the image reading position.

The image sensor 125 generates image data of the original corresponding to each color of R (red), G (green) and B (blue), for example, from the optical image incident on the acceptance surface.

The image forming portion 140 prints (forms) an image based on the image data obtained by the image reading portion 120 or received from other devices (not shown) connected to a network 162, via a network adaptor 161.

The image forming portion 140 includes a photoreceptor drum 141.

The photoreceptor drum 141 rotates about a rotational axis in one direction at a constant speed.

In the periphery of the photoreceptor drum 141, a charging device 142, an exposure device 143, a developing device 144, and an intermediate transfer belt 145 are disposed.

The charging device 142 uniformly charges a surface of the photoreceptor drum 141.

The exposure device 143 irradiates the surface of the photoreceptor drum 141 uniformly charged with light according to the image data, thereby forming an electrostatic latent image on the photoreceptor drum 141.

The developing device 144 deposits toner on the electrostatic latent image, thereby forming (developing) a toner image on the photoreceptor drum 141.

The intermediate transfer belt 145 transfers the toner image on the photoreceptor drum 141 to the paper. In a case where the image data is a color image, the intermediate transfer belt 145 transfers toner images of respective colors on the same paper. The color image in the RGB format is transferred into image data of C (cyan), M (magenta), Y (yellow) and K (black), and the image data of these colors is input to the exposure device 143.

The image forming portion 140 feeds the paper from a manual feeding tray 151, paper feeding cassettes 152, 153 and 154, and the like to the transfer portion between the intermediate transfer belt 145 and a transfer roller 146.

The manual feeding tray 151 and the paper feeding cassettes 152, 153 and 154 can carry or house various sizes of paper.

The image forming portion 140 selects the paper specified by a user or the paper corresponding to a size of original automatically detected by a predetermined sensor or the like, and then pulls the paper thus selected out from the manual feeding tray 151 and the paper feeding cassettes 152, 153 and 154. The paper thus pulled out is fed to the transfer portion by the transfer roller 156 and the resist roller 157.

The paper onto which the toner image is transferred is then fed to a fixing device 148 by a paper feeding belt 147.

The fixing device 148 includes a fixing roller 158 including a heater and a pressurizing roller 159. The fixing device 148 fixes the toner image onto the paper by applying heat and a pressing force by the fixing roller 158 and the pressurizing roller 159.

The image forming portion 140 ejects the paper having passed through the fixing device 148 to an ejected paper tray 149.

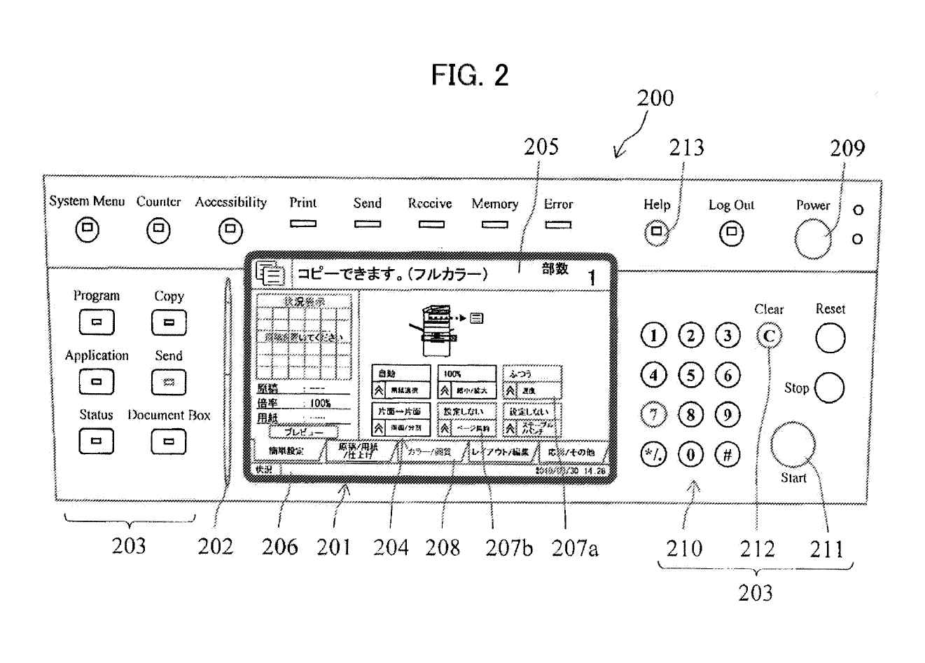

FIG. 2 is a diagram showing an example of an external appearance of the operation panel provided in the multi-function peripheral.

A user can use the operation panel 200 to give an instruction of starting copying and the like to the multi-function peripheral 100, and to confirm a state and settings of the multi-function peripheral 100.

In the operation panel 200, a display 201 with touch panel and an operation key 203 are disposed.

The display 201 is provided with a display face that is composed of a liquid crystal display or the like and displays operation buttons and messages, and a sensor that detects a pressed (touched) position on the display face. A method for detecting the pressed position is not particularly limited and can be accordingly selected from: a resistance film method; a capacitance method; a surface acoustic wave method; an electromagnetic wave method; and the like. A user can perform input through the display 201, using his/her fingers or a stylus 202.

The display 201 displays the operation screen including a button display portion 204, a message display portion 205, and a status display portion 206.

In the button display portion 204, a plurality of tabs 208 are provided. In each tab, operation buttons corresponding to a category of the tab are arranged.

A “Quick Setup” tab includes operation buttons used for basic settings. In the example shown in FIG. 2, operation buttons are arranged (displayed) for setting paper size, zoom, density, duplex copying, combine, and post processing.

For example, if a user presses the “Density” button 207a, a pop-up screen is superimposed thereon showing selection buttons for selecting density such as “Light”, “Normal”, “Dark” and the like. If the user selects (presses) any of the buttons, the density thus selected is set.

In the example of FIG. 2, in addition to the “Quick Setup” tab, an “Original/Paper/Finishing” tab, a “Color/Image Quality” tab, a “Layout/Edit” tab, and an “Advanced Setup” tab are provided (on a lower side of the display portion).

These tabs can be displayed by selection of a tab button 208 by the user. While one of these tabs is selected, other tabs and elements thereof are hidden.

The message display portion 205 displays messages for notifying current settings, such as availability of copy function, copy quantity and the like, to a user.

In the example shown in FIG. 2, the message display portion 205 displays messages “Ready to copy (full color)” and “Copies 1”. The messages notify the user that a setting for copying 1 copy in full-color is made (by the user).

In the status display portion 206, apparatus status information is displayed as necessary. The apparatus status information thus displayed reflects detection results of various sensors provided in the multi-function peripheral 100.

The apparatus status information is a message for prompting the user to deal with an abnormality, in a state in which the apparatus is still operable despite the abnormality. For example, the apparatus status information includes: low remaining amount of paper; the platen 103 being dirty; facsimile document being stored in memory (in a case where receipt of facsimile by memory being set); and the like. Paper out, paper jam and the like can also be included in the apparatus status information.

The operation key 203 includes: a main power key 209; numerical keypad 210; a start key 211; a clear key 212; a help key 213 and the like.

For example, the main power key 209 is used for turning on and off the main power of the multi-function peripheral 100.

The numerical keypad 210 can be used for setting of copy quantity and zoom.

The start key 211 is used for instructing the apparatus to start coping or printing.

The clear key 212 can be used to clear settings made by a user. Settings by a user, which are displayed in the message display portion 205, can be cleared by operating the clear key 212 when the settings are no longer needed.

The help key 213 is used for displaying introduction and description of usage and operation method of each function of the multi-function peripheral 100 on the display 201.

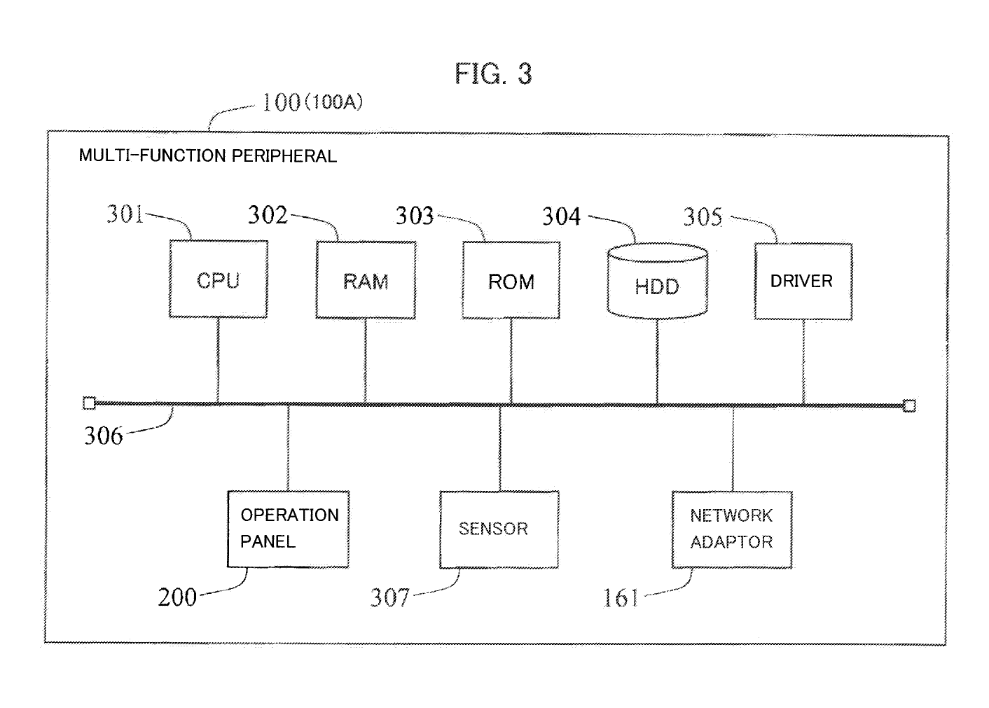

FIG. 3 is a hardware configuration diagram of a control system of the multi-function peripheral.

The multi-function peripheral 100 of the present embodiment includes: a CPU (Central Processing Unit) 301; RAM (Random Access Memory) 302; ROM (Read Only Memory) 303; and a HDD (Hard Disk Drive) 304 that are connected to each other via an internal bus 306, as well as: the original feeder 110; the image reading portion 120; and a driver 305 corresponding to each driving portion in the image forming portion 140.

The ROM 303, the HDD 304 and the like store a control programs.

The CPU 301 controls the multi-function peripheral 100 according to an instruction of the control program thus stored. In addition, for example, the CPU 301 controls operation of the each driving portion by using the RAM 302 as a work area and transmitting and receiving data and instructions with respect to the driver 305.

The HDD 304 is used for accumulating image data obtained by the image reading portion 120 and image data received from other devices via the network adaptor 161.

To the internal bus 306, the operation panel 200 and the various sensors 307 are connected.

The operation panel 200 accepts a user's operation and supplies a signal based thereon to the CPU 301.

The display 201 displays the abovementioned operation screen according to a control signal from the CPU 301.

The sensors 307 include: an opening/closing sensor of the platen cover 102; an original sensor on the platen 103; a temperature sensor of the fixing device 148; a sensor for the paper or original being fed; and the like.

The CPU 301 realizes the following means (function blocks) by executing programs stored in the ROM 303, for example, and controls operation of the means based on the signal from these sensors.

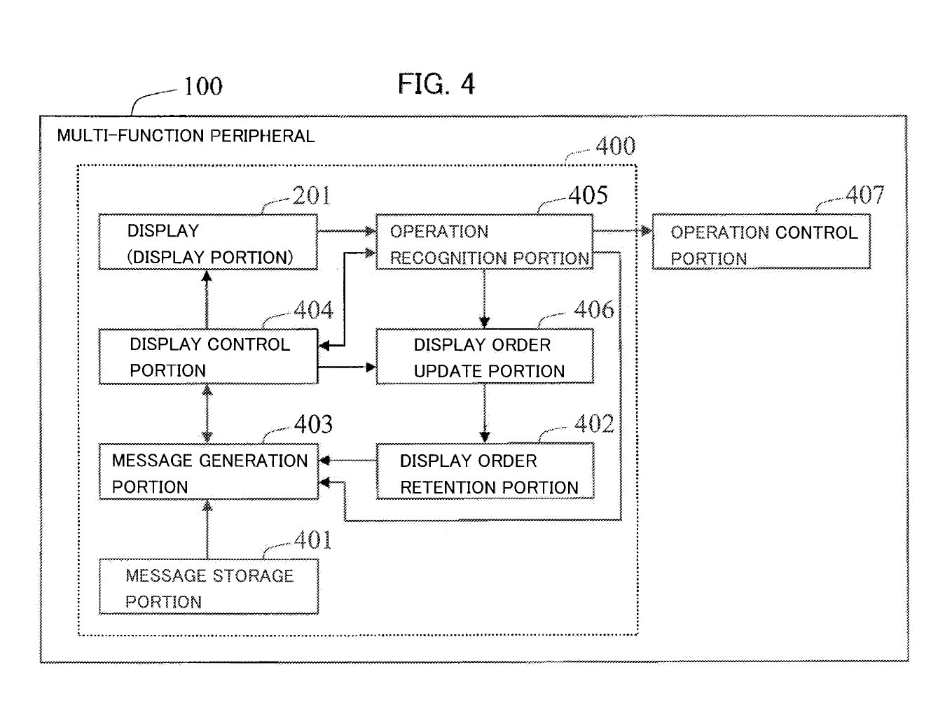

FIG. 4 is a function block diagram of the multi-function peripheral of the present embodiment.

As shown in FIG. 4, the multi-function peripheral 100 of the present embodiment includes: a message storage portion 401; a display order retention portion 402; a message generation portion 403; a display control portion 404; an operation recognition portion 405; a display order updating portion 406; and an operation control portion 407.

In the present example, the display 201, the message storage portion 401, the display order retention portion 402, the message generation portion 403, the display control portion 404, the operation recognition portion 405, and the display order updating portion 406 compose a help display device 400.

The message storage portion 401 stores identical help messages expressed in a plurality of languages. The help messages include messages introducing and describing usage and operation method of functions of the multi-function peripheral 100 and messages indicating usage and the like of functions assigned to the operation buttons of the operation screen.

The display order retention portion 402 retains display orders of the plurality of languages. Here, the display order retention portion 402 retains correspondence between the display order and the display language as a language display order table.

In response to a help message display instruction from a user, the message generation portion 403 reads the help message corresponding to the instruction from the message storage portion 401.

And then, the message generation portion 403 generates a multilingual help message by arranging the help messages of each language thus read in the display order retained in the display order retention portion 402.

More specifically, a user operates the operation portion to give an instruction of displaying a help message (pressing a predetermined operation button or the like). The operation portion accepts an instruction for displaying a predetermined help message on the display 201 (the display portion) and outputs information indicating the acceptance to the message generation portion 403. And then, the message generation portion 403 reads the help message corresponding to the instruction from the message storage portion 401 and generates a multilingual help message by arranging the help messages of each language thus read in the display order retained in the display order retention portion 402.

The display control portion 404 displays the abovementioned operation screen and a message display screen displaying the multilingual help message on the display face of the display 201.

The display control portion 404 retains information indicating display positions of the operation buttons and messages (for example, coordinates on the display screen) included in the operation screen and the message display screen.

An operation made on the display face of the display 201 is detected by the sensor that detects the pressed position on the display 201 and the coordinate of the pressed position is obtained by the operation recognition portion 405. In the present embodiment, the display 201 is a touch-panel display being the display portion and the operation portion (partially).

The operation recognition portion 405 recognizes a type of the user's operation based on coordinates of screen elements retained by the display control portion 404 and the pressed position. The operation recognition portion 405 also recognizes pressing of the operation key 203 of the operation panel 200.

It should be noted that, in the present embodiment, a configuration in which the display 201 functions as the display portion that displays the help messages is employed as an especially preferred embodiment; however, a configuration in which the display portion that displays the help messages is different from the display 201 can also be employed in the absence of layout limitation.

For example, when a user presses the help key 213, the operation recognition portion 405 recognizes and notifies the pressing to the message generation portion 403. The message generation portion 403 recognizes a help message relating to an item included in the operation screen displayed on the display 201 by the display control portion 404 as a help message to be displayed. The message generation portion 403 reads the help message to be displayed from the message storage portion 401 and generates the multilingual help message. Alternatively, a configuration can be employed in which, when a user presses the help key 213, the display control portion 404 displays selection buttons, which are assigned to the help messages stored in the message storage portion 401, being sorted by categories, and recognizes a help message corresponding to the selection button selected by the user as the help message to be displayed.

The display order updating portion 406 updates the display order retained in the display order retention portion 402 to a state in which the default display language comes first in the display order. For example, a configuration can be employed in which, when the operation recognition portion 405 recognizes the user's operation of changing the default display language, new default display language is notified to the display order updating portion 406. In addition, the display order updating portion 406 updates the display order retained in the display order retention portion 402 based on the referred frequency of the help message of each language in the multilingual help message. The referred frequency can be obtained (counted) by detecting the language of the help message referred to by the user in the multilingual help message displayed on the display 201. For example, the language of the help message can be detected at the end of reference to the help message (when the user closes a help message display screen).

The operation control portion 407 executes generation of image data in the image reading portion 120, printing of the image data in the image forming portion 140 and the like, based on a user's instruction via the operation screen and the like, detected by the operation recognition portion 405.

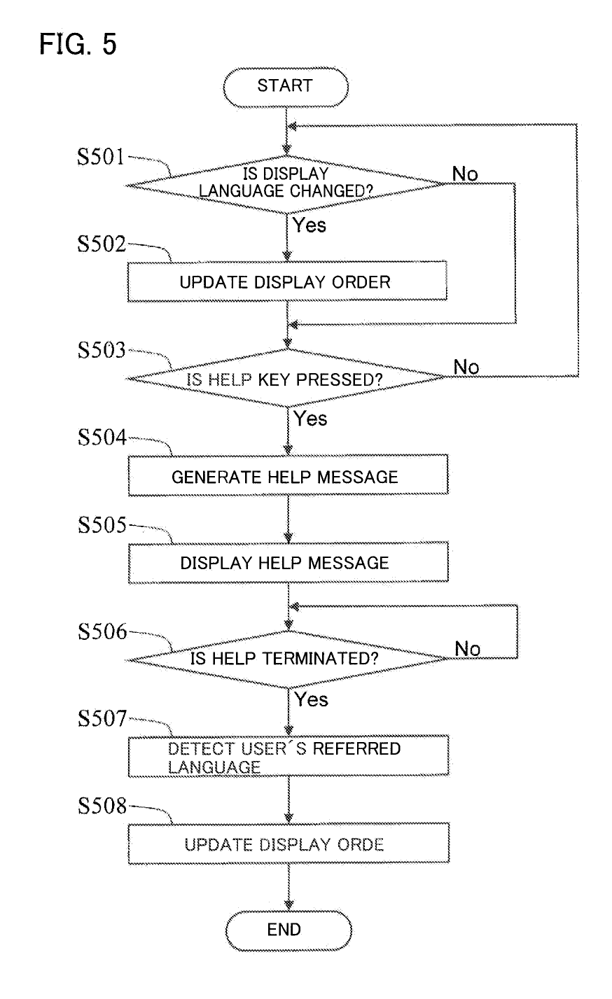

FIG. 5 is a diagram showing an example of a multilingual help message display procedure executed by the help display device 400 included in the multi-function peripheral.

The procedure is triggered by, for example, detection by the operation recognition portion 405 of pressing of the help key 213 (Step S503). Hereinafter, a case of the help key 213 being pressed, in a state in which a combine setup screen is displayed on the display 201 as a result of a user pressing a “Combine” button 207b in the operation screen shown in FIG. 2, is described. In addition, as shown in FIG. 2, the default display language (a predetermined display language) is set to Japanese.

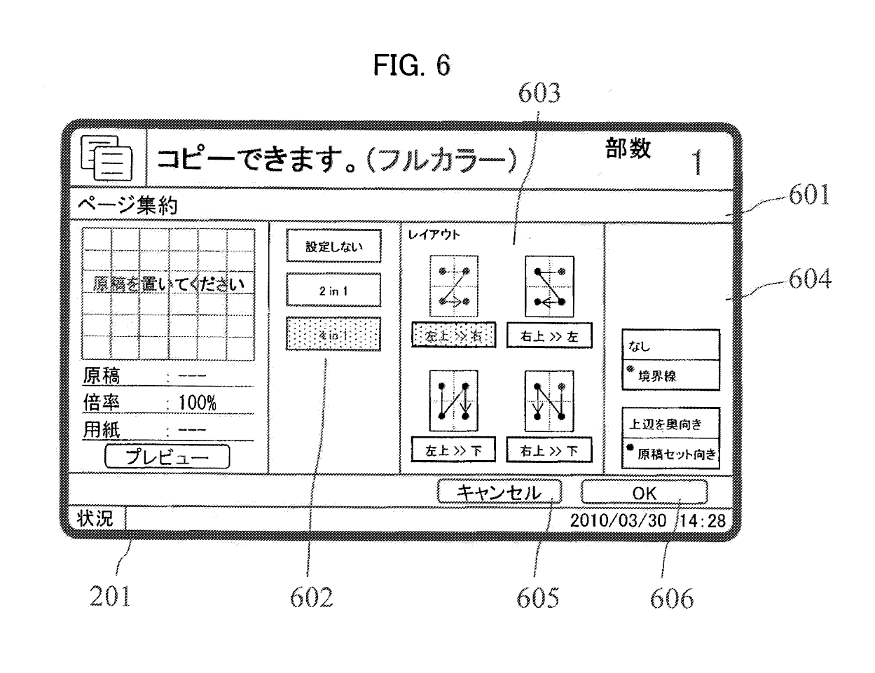

First, the combine setup screen is described. FIG. 6 is a diagram showing an example of the combine setup screen. In this example, the combine setup screen 601 includes: a combine type selection column 602; a layout selection column 603; an option selection column 604; a “Cancel” button 605 used for canceling setup and displaying an initial operation screen shown in FIG. 2; and an “OK” button 606 to be selected upon completion of setup.

In the combine type selection column 602, an “Off” button, a “2 in 1” button for combining 2 pages of original into one page, and a “4 in 1” button for combining 4 pages of original into one page are arranged for selecting combine types.

In the layout selection column 603, a “Right then Down” button, a “Left then Down” button, a “Down then Right” button, and a “Down then Left” buttons are arranged for selecting layout of combined pages. FIG. 6 shows the layout selection column 603 displayed in a case in which the “4 in 1” button is selected in the combine type selection column 602.

In the option selection column 604, a “Border Line” selection column for selecting presence/absence of border line, an “Original Orientation” selection column for selecting orientation of the original placed on the platen 103 or the original feeder 110, are arranged.

When a user presses the help key 213 in a state in which the abovementioned combine setup screen 601 is displayed on the display 201, the operation recognition portion 405 notifies the pressing to the message generation portion 403 (Step S503Yes).

The procedure does not advance unless the operation recognition portion 405 detects the pressing of the help key 213 (Step S503No).

In addition, if the default display language is changed before the help key 213 being pressed, the language display order table retained by the display order retention portion 402 is updated (Step S501Yes, S502). Update of the language display order table is described later.

In response to the abovementioned notification, the message generation portion 403 reads the help message to be displayed from the message storage portion 401 and generates a multilingual help message according to the display order retained in the display order retention portion 402 (Step S504).

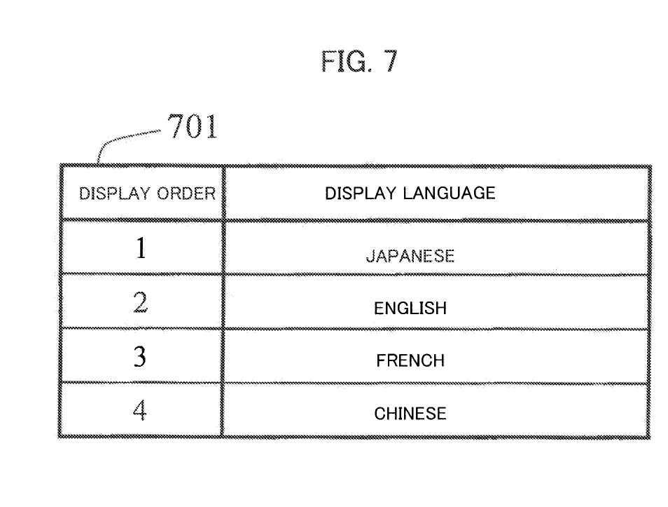

FIG. 7 is a diagram showing an example of the language display order table retained by the display order retention portion 402. As shown in FIG. 7, the language display order table 701 is a table for storing a language display order and the display languages being associated to each other. In the example of FIG. 7, four display languages “Japanese”, “English”, “French”, “Chinese” are associated respectively to “First”, “Second”, “Third”, and “Fourth” display order. Although an example of using four languages is shown herein, it is obvious that the number of languages can be accordingly selected.

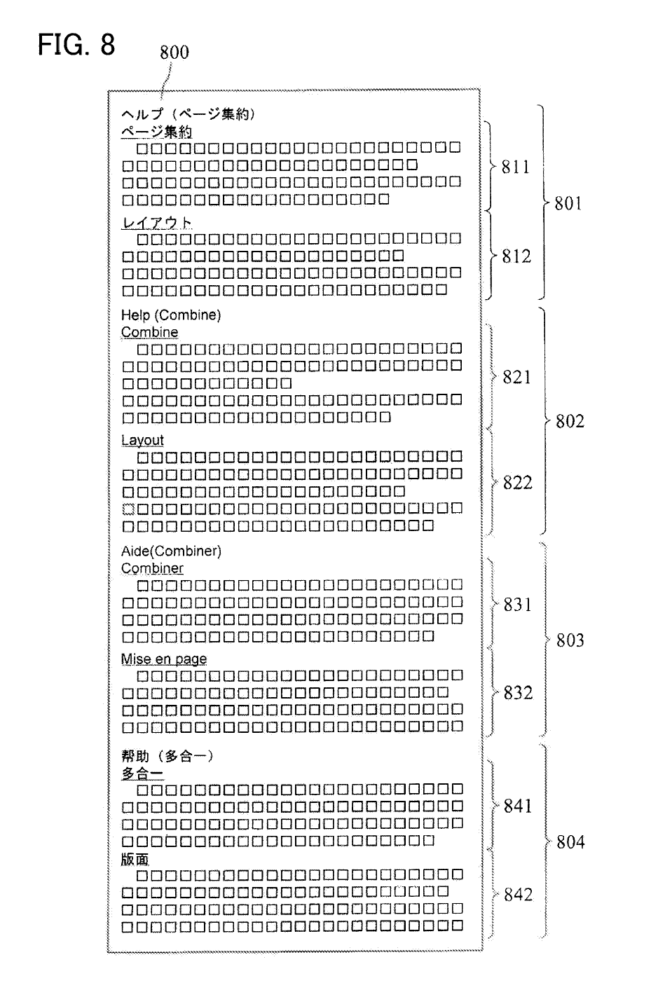

FIG. 8 is a diagram showing an example of the multilingual help message generated by the message generation portion 403 based on the language display order table 701. For the sake of description, a multilingual help message 800 shown here is composed only from message groups describing “Combine” and “Layout”, and messages for other items are omitted.

The multilingual help message 800 includes: a message portion 801 expressed in Japanese, which is the default display language and of which display order is “First”; a message portion 802 expressed in English of which display order is “Second”; a message portion 803 expressed in French of which display order is “Third”; and a message portion 804 expressed in Chinese of which display order is “Fourth”.

The message portions 801 to 804 include message portions 811, 821, 831 and 841 relating to the item “Combine” and message portions 812, 822, 832 and 842 relating to the item “Layout”, respectively.

The message portions 801 to 804 are arranged according to the display order of the language display order table 701 in a vertical direction, which is a scrolling direction (described later) of the message display screen.

Therefore, when a user scrolls the multilingual help message 800 in the message display screen, the message portions 801 to 804 expressed in these display languages are displayed sequentially in this order.

The message storage portion 401 can store help messages either in units of the message portions 801 to 804 or in units of the items 811, 812, 821, 822, 831, 832, 841 and 842. In addition, the help messages stored in the message storage portion 401 can be either text data or image data. For composition of these help messages, any method can be employed such as a composition method using a markup language, an image composition method and the like.

The message generation portion 403 having generated the multilingual help message 800 displays the multilingual help message 800 thus generated on the display 201 via the display control portion 404 (Step S505).

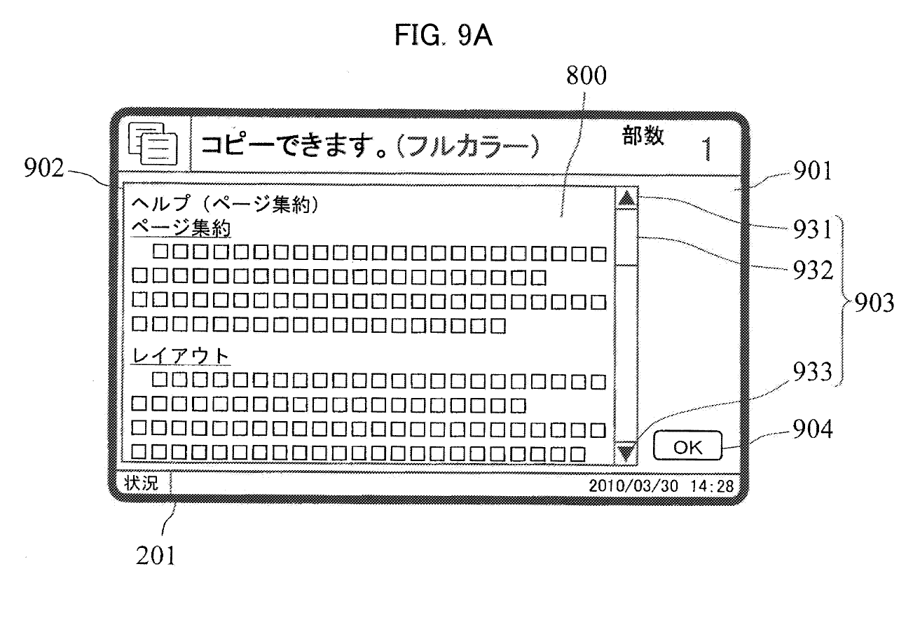

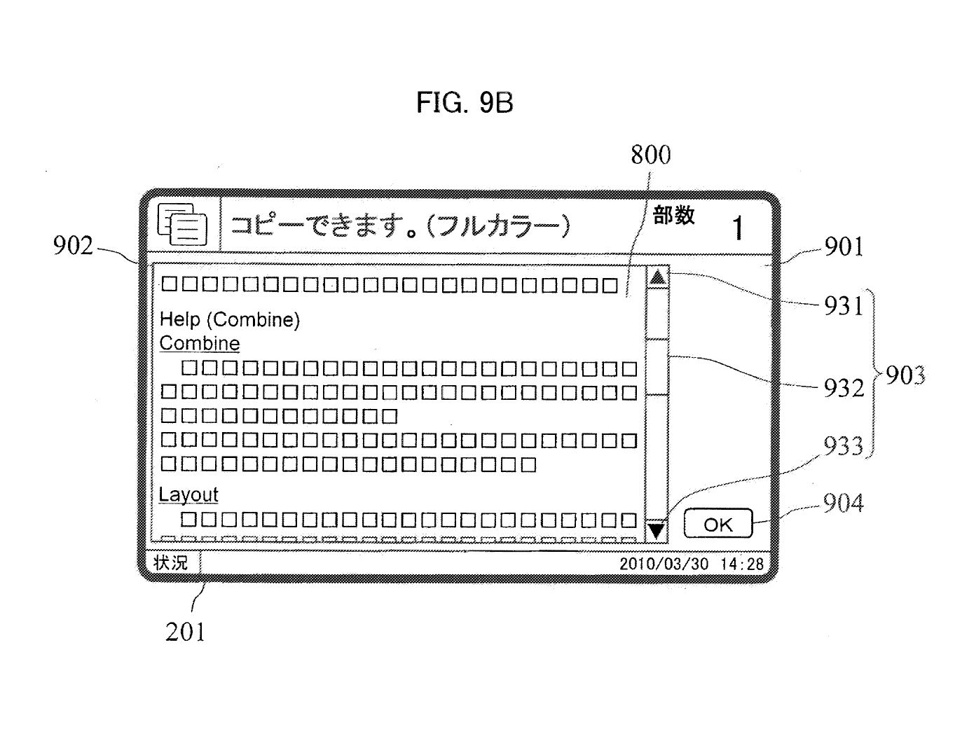

FIGS. 9A and 9B are diagrams showing an example of the message display screen that is displayed when a user presses the help key 213 in a state in which the combine setup screen 601 is displayed on the display 201. As shown in FIGS. 9A and 9B, the message display screen 901 includes: a message display column 902 that displays the help message; a scroll bar 903 provided in a right end of the message display column 902; and an “OK” button 904 that is to be selected for closing the message display screen 901 and returning to the combine setup screen.

The scroll bar 903 includes an upward scroll arrow 931, a knob 932, and a downward scroll arrow 933. As commonly known, the upward scroll arrow 931 is used to move the multilingual help message 800 displayed in the message display column 902 downward to show a region above the region displayed at that moment. The downward scroll arrow 933 is used to move the multilingual help message 800 displayed in the message display column 902 upward to show a region below the region displayed at that moment. A scroll size for the upward scroll arrow 931 and the downward scroll arrow 933 can be appropriately set to a specified number of lines, a page, and the like. The knob 932 is used for moving a displayed region and shows a position of the displayed region in the entire multilingual help message 800 and a proportion of the displayed region to the entire multilingual help message 800. FIG. 9A shows a state in which an uppermost part of the multilingual help message 800 is displayed in the message display column 902. FIG. 9B shows a state in which a lowermost line displayed in the message display column 902 of FIG. 9A is displayed as an uppermost line in the message display column 902.

In the present embodiment, when a user presses the “OK” button 904 in the message display screen 901, the display order update portion 406 detects the language of the message referred to by the user in the multilingual help message 800 displayed on the display 201 (Step S506Yes, S507). Here, in response to an input from the operation recognition portion 405 indicating the pressing on the “OK” button 904, the display order update portion 406 retrieves a help message display history from the display control portion 404. The display order update portion 406 detects the language of the message referred to the user based on the help message display history thus retrieved.

The help message display history is information representing a history of a display state (displayed region and display period) of the multilingual help message 800 in the message display column 902, during a period from opening to closing of the message display screen 901.

For example, in a case in which a help message of a single language (e.g. only one of the message portions 801 to 804) is recorded in the help message display history as the message displayed upon closing of the message display screen 901, the display order update portion 406 can detect the language as the language of the message referred to by the user.

On the contrary, in a case in which a help message of a plurality of languages is recorded in the help message display history as the message displayed upon closing of the message display screen 901, the display order update portion 406 detects the language of the message referred to by the user from the help message display history, based on an areal proportion of these languages in the message display column 902, a display period of these languages, and a scroll history.

For example, in the example of FIG. 9B, the message portion 801 in Japanese and the message portion 802 in English are displayed in the message display column 902. In this example, if an operation of quickly scrolling from the state of FIG. 9A to the state of FIG. 9B and then staying for a certain amount of time in the state of FIG. 9B is recorded in the help message display history, the display order update portion 406 can determine English, which is a language of a greater areal proportion, as the language of the message referred to by the user. Such a determination can be made also by calculating a sum of products of a time period for which the message has stayed in the message display column 902 by an areal proportion thereof in the message display column 902 during the time period, for each language. Alternatively, in a case in which downward scroll and stopping are repeatedly performed, a language in the uppermost position (a language being the first in the display order) can be simply determined to be the language of the message referred to by the user.

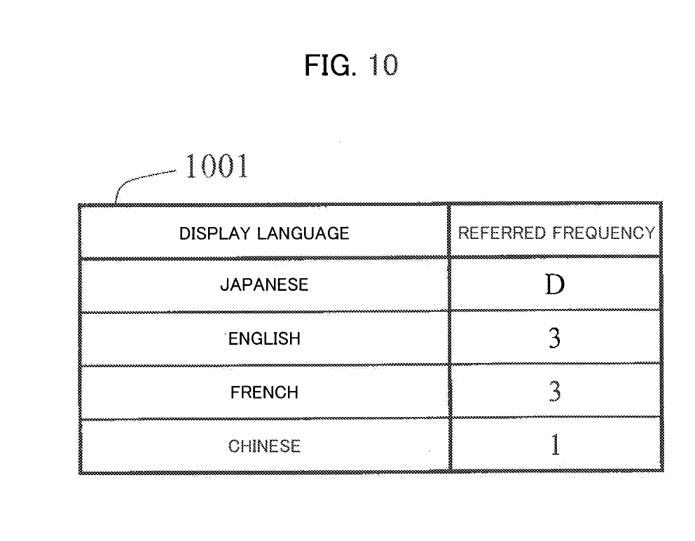

The display order update portion 406, which has thus determined the language of the message referred to by the user, records the referred language thus determined. In the present embodiment, the display order update portion 406 retains information regarding the referred language as the referred frequency table. FIG. 10 is a diagram showing an example of the referred frequency table. As shown in FIG. 10, the referred frequency table 1001 is a table for storing the display languages and referred frequencies being associated to each other. In the example of FIG. 10, four display languages “Japanese”, “English”, “French”, “Chinese” are associated respectively to the referred frequencies “D”, “3”, “3”, and “1”. The referred frequency “D” indicates the default display language. If the display order update portion 406 determines “Chinese” as the referred language in such a state, the referred frequency “1” associated to the display language “Chinese” is updated to “2”. Although the number of times the languages are referred to is recorded as the referred frequencies, any information representing referred frequencies can be employed. For example, a total amount of time the languages are referred to can be employed. The total amount of time of reference also can be determined from the help message display history.

After updating the referred frequency table 1001, the display order update portion 406 updates the language display order table 701 based on the referred frequency table 1001 (Step S508). Here, the display order update portion 406 sorts the display languages except for the language with the referred frequency “D” (“English”, “French” and “Chinese” here) in a descending order of frequency. In the example of the FIG. 10, the display languages are sorted in an order of “English”, “French” then “Chinese”; however, the language display order table 701 shown in FIG. 7 is not updated since the display order in the table is already in this order. In the present embodiment, the display order update portion 406 is configured not to change the display order of languages of the same referred frequency (“English” and “French” here) in the language display order table 701, although not particularly limited thereto.

Next, a case in which the default display language is changed in Step S501 shown in FIG. 5 is described. When the operation recognition portion 405 recognizes the user's operation of changing the default display language by accessing the system menu, the operation recognition portion 405 notifies a new default display language to the display order updating portion 406 (Step S501Yes). A case of changing the default display language from “Japanese” to “English” is described hereinafter.

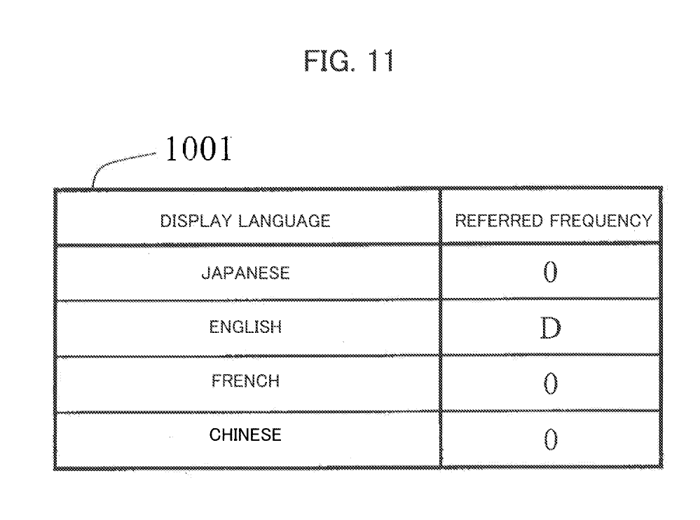

In response to the notification, the display order update portion 406 updates the referred frequency table 1001 based on the new default display language (“English” here). FIG. 11 is a diagram showing an example of the referred frequency table 1001 thus updated. As shown in FIG. 11, the referred frequency “D” is associated to the display language “English”. In the present embodiment, according to the change of the default display language, the referred frequencies of other languages are reset, although not particularly limited thereto.

After updating the referred frequency table 1001, the display order update portion 406 updates the language display order table 701 based on the referred frequency table 1001 (Step S502). As described above, the display order update portion 406 sorts the display languages except for the language with the referred frequency “D” (“Japanese”, “French” and “Chinese” here) in a descending order of frequency. Here, the display order of languages of the same referred frequency is not changed in the language display order table 701. In the referred frequency table 1001 shown in FIG. 11, since the referred frequencies of the display languages other than “English”, which is the default display language, are the same, the display order is updated such that “English” comes first and relative orders of other display languages are not changed.

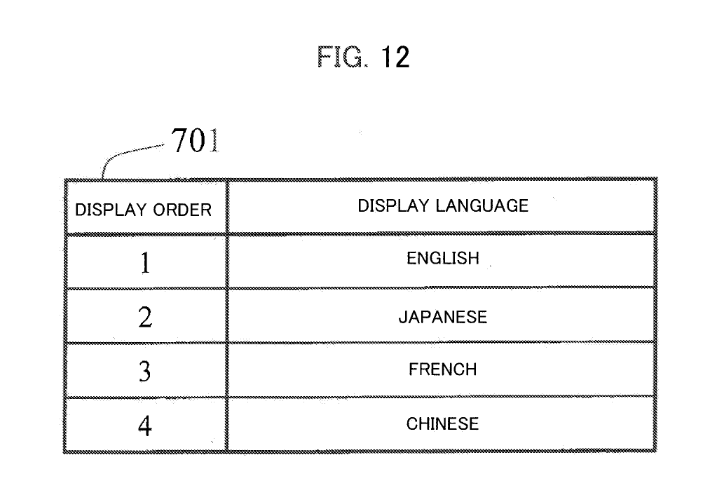

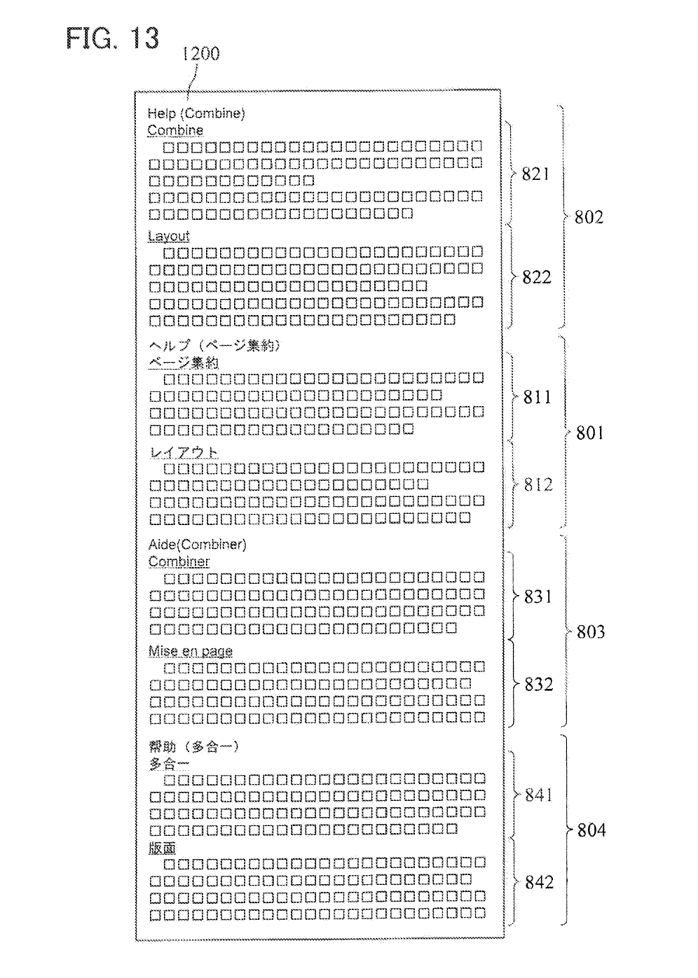

FIG. 12 is a diagram showing the language display order table 701 thus updated. As a result of the above-mentioned change, the four display languages “English”, “Japanese”, “French”, “Chinese” are associated respectively to First, Second, Third, and Fourth display order. FIG. 13 is a diagram showing an example of the multilingual help message to be displayed on the display 201 (display portion), generated by the message generation portion 403 based on the language display order table 701 shown in FIG. 12 (Step S503Yes, 5504, S505). In the multilingual help message 1200, the message portion 802 expressed in English, which is the default display language and of which display order is “First”; the message portion 801 expressed in Japanese of which display order is “Second”; the message portion 803 expressed in French of which display order is “Third”; and the message portion 804 expressed in Chinese of which display order is “Fourth”, are arranged in this order in a scroll direction of the message display column 902.

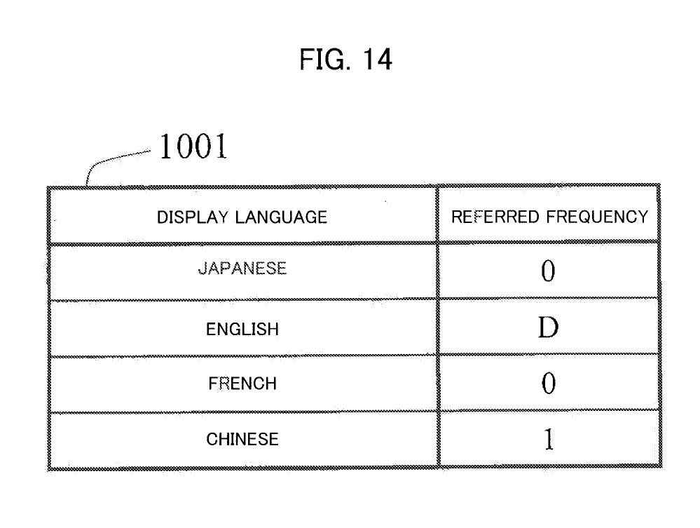

If a user then refers to the message portion 804 in Chinese in the multilingual help message 1200 in such a state, the display order update portion 406 updates the referred frequency “0”, which has been associated to the display language “Chinese” in the referred frequency table 1001, to “1” as shown in FIG. 14 (Step S506Yes, S507). Thereafter, the display order update portion 406 updates the language display order table 701 based on the referred frequency table 1001 (Step S508).

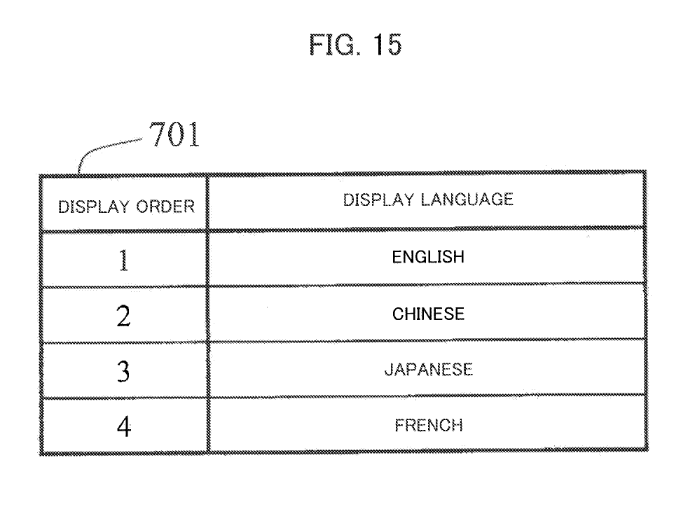

FIG. 15 is a diagram showing the language display order table 701 thus updated. As a result of the above-mentioned change, the four display languages “English”, “Chinese”, “Japanese”, “French” are associated respectively to First, Second, Third, and Fourth display order.

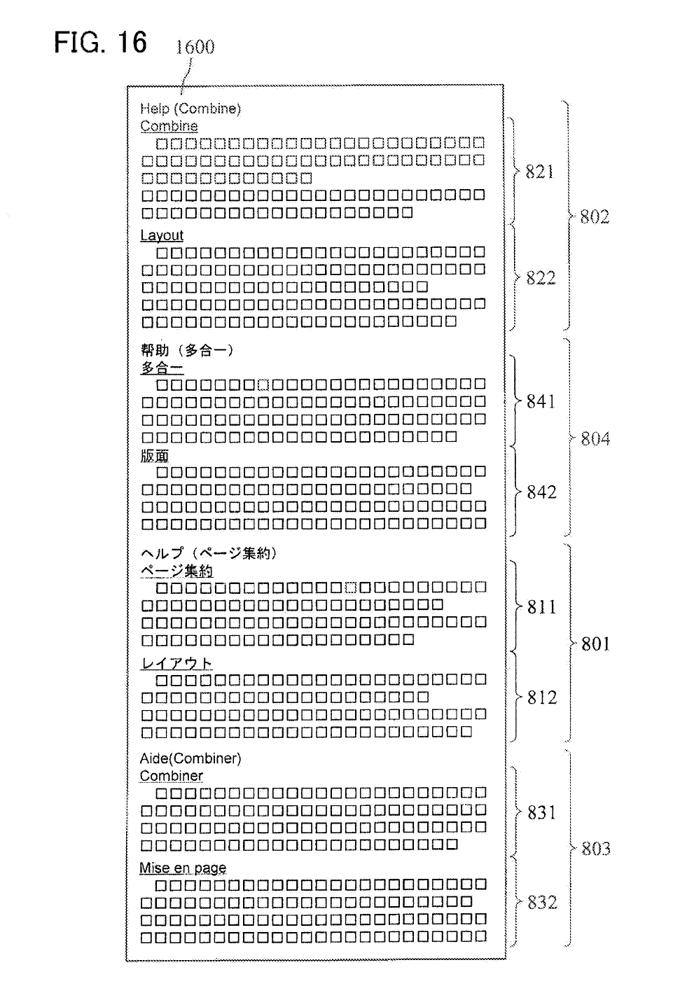

FIG. 16 is a diagram showing an example of the multilingual help message to be displayed on the display 201, generated by the message generation portion 403 based on the language display order table 701 shown in FIG. 15.

In the multilingual help message 1600, the message portion 802 expressed in English, which is the default display language and of which display order is “First”; the message portion 804 expressed in Chinese of which display order is “Second”; the message portion 801 expressed in Japanese of which display order is “Third”; and the message portion 803 expressed in French of which display order is “Fourth”, are arranged in this order in a scroll direction of the message display screen 902.

As described above, in the multi-function peripheral 100, the multilingual help message is generated according to the display order retained in the display order retention portion 402.

In other words, by changing the display order retained in the display order retention portion 402 according to the change in the default display language, the multi-function peripheral 100 can display the multilingual help message suitable for its user easily and efficiently. In addition, the display language can be easily added afterward, and the multi-function peripheral 100 can easily display the multilingual help message on the display 201 even in a case of the display language being added afterward.

In addition, by providing the display order updating portion 406 that updates the display order retained in the display order retention portion 402 to a state in which the default language comes first in the display order, the multifunction peripheral 100 automatically changes the language display order of the multilingual help message in a case where the default display language is changed according to shipping destination, such as a foreign country and the like.

In addition, since the display order updating portion 406 is configured to update the language display order retained in the display order retention portion 402 based on the referred frequency of the help message of each language in the multilingual help message, the multi-function peripheral 100 automatically updates the language display order of the multilingual help message to a state suitable for an actual usage environment. A user can thus refer to the multilingual help message efficiently.

It should be noted that the above embodiment is not intended to limit a technical scope of the present invention and various modifications and applications can be made in addition to the above description within the scope of the present invention. For example, in the above embodiment, the present invention has been described based on operations through the operation panel of the multi-function peripheral; however, operations can be made through an information processing terminal such as personal computer communicatively connected to the multi-function peripheral. In this case, a function of the display 201 of the operation panel 200 as in the above embodiment is provided by a display means such as a display and an input means such as a keyboard provided in the information processing terminal.

In addition, in the flow chart shown in FIG. 5, the order of the steps can be changed within a scope of providing the similar effect. For example, in the above embodiment, a configuration is employed in which the referred language is determined upon closing of the message display screen; however, the similar effect can be provided by determining the referred language continuously and performing the update upon closing of the message display screen.

Furthermore, in the above embodiment, a configuration providing the display order update portion is described as an especially preferred embodiment; however, the display order update portion is not an essential constituent of the invention of the present application. For example, even in a configuration without the display order update portion, at least the language display order of the multilingual help message can be appropriately changed and the display language can be easily added afterward. Alternatively, the display order updating portion 406 can be configured to only update the display order retained in the display order retention portion to a state in which the default language comes first in the display order.

In a case where the multi-function peripheral has an authentication function that identifies users, the language display order table and the referred frequency table can be provided for each user. Each user can thus refer to the multilingual help message more efficiently.

In addition, in the above embodiment, the present invention is concretized as a digital multi-function peripheral; however, the present invention is not limited thereto and can be applied to any electronic apparatus, for example image forming apparatuses such as printers, copy machines and the like. In other words, the present invention provides an effect of a help display device.

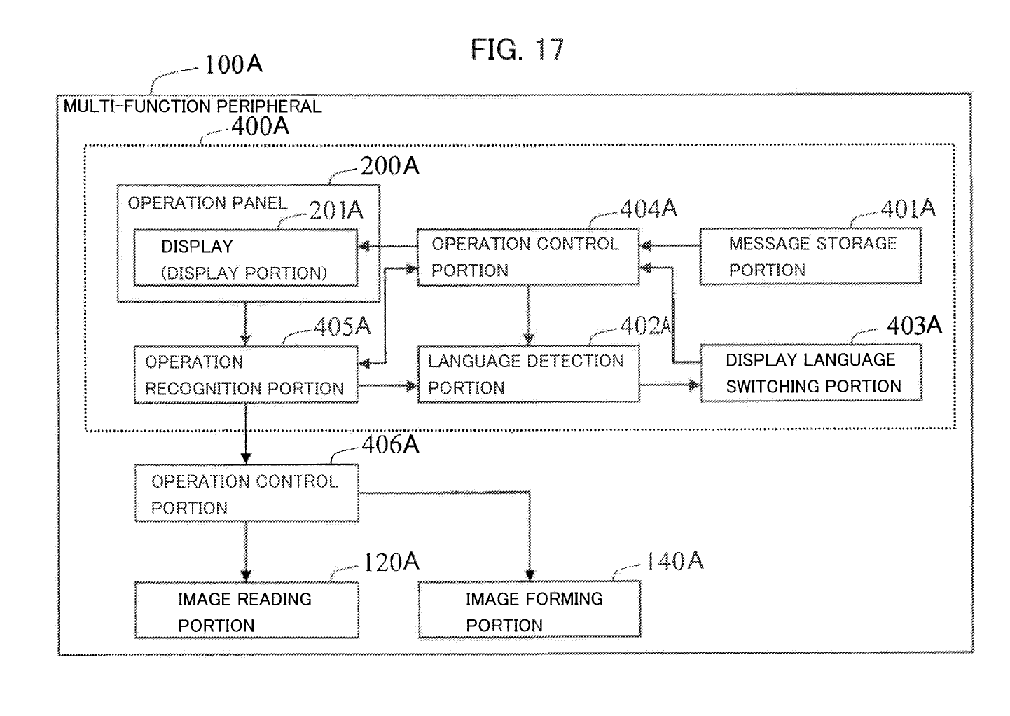

Next, a second embodiment of the present invention is described with reference to FIGS. 17 to 23.

FIG. 17 is a function block diagram of the multi-function peripheral of the present embodiment.

As shown in FIG. 17, the multi-function peripheral 100A of the present embodiment includes: a message storage portion 401A; a language detection portion 402A; a display language switching portion 403A; a display control portion 404A; an operation recognition portion 405A; and an operation control portion 406A. In this example, an operation panel 200A, the message storage portion 401A, the language detection portion 402A, the display language switching portion 403A, the display control portion 404A and the operation recognition portion 405A compose an operation device 400A.

The message storage portion 401A stores identical help messages expressed in a plurality of languages. The help messages include messages introducing and describing usage and operation method of functions of the multi-function peripheral 100A and messages indicating usage and the like of functions assigned to the operation buttons of the operation screen. The help messages are read by the display control portion 404A and displayed on the display face of the display 201A.

It should be noted that, in the present embodiment, a configuration in which the display 201A functions as the display portion that displays the help messages is employed as an especially preferred embodiment; however, a configuration in which the display portion that displays the help messages is different from the display 201A can also be employed in the absence of layout limitation.

In addition, in the present embodiment, the operation screen displayed on the display 201A functions as the operation portion including operation buttons with contents in a predetermined display language (hereinafter referred to as “default display language”). In the present embodiment, the display 201A is a touch-panel display being the display portion and the operation portion (partially). In the present embodiment, the display 201A (the operation portion) accepts an instruction for displaying a predetermined help message on the display 201A (the display portion).

Here, the default display language is set to Japanese.

The display control portion 404A displays the abovementioned operation screen and a message display screen displaying the help message on the display face of the display 201A.

The display control portion 404A retains information indicating display positions of the operation buttons and messages (for example, coordinates on the display screen) included in the operation screen and the message display screen.

An operation made on the display face of the display 201A is detected by the sensor that detects the pressed position on the display 201A and the coordinate of the pressed position is obtained by the operation recognition portion 405A.

The operation recognition portion 405A recognizes a type of the user's operation based on coordinates of screen elements retained by the display control portion 404A and the pressed position. The operation recognition portion 405A also recognizes pressing of the operation key 203A of the operation panel 200A.

For example, when a user presses the help key 213A and the operation recognition portion 405A recognizes the pressing, the display control portion 404A reads the help message to be displayed from the message storage portion 401A and displays on the display 201A. The display control portion 404A sequentially displays identical help messages expressed in a plurality of languages, as described later.

Here, the display control portion 404A recognizes the help message relating to an item included in the operation screen displayed on the display 201A as a help message to be displayed. Alternatively, a configuration can be employed in which, when a user presses the help key 213A, the display control portion 404A displays selection buttons, which are assigned to the help messages stored in the message storage portion 401A, being sorted by categories, and recognizes a help message corresponding to the selection button selected by the user as the help message to be displayed.

The language detection portion 402A detects the language of the help message referred to by the user in the multilingual help message displayed on the display 201A. Such a detection is performed, for example, at the end of reference to the help message (when the user closes a help message display screen).

The display language switching portion 403A switches the display language of the operation screen to the language detected by the language detection portion 402A. In a case in which the language detected by the language detection portion 402A is different from the predetermined display language (the default display language), the display language switching portion 403A switches the display language of the display 201A to the language detected by the language detection portion 402A.

After switching the display language, when a preregistered display language switching termination condition is satisfied, the display language switching portion 403A switches the display language of the operation screen of the display 201A to the default display language.

Here, the display language switching termination condition is an elapsed time period since the language switching portion 403A has switched the display language displayed on the display 201A to the language detected by the language detection portion 402A. In other words, the display language switching portion 403A switches the display language of the display 201A back to the default display language when a predetermined time has elapsed since the display language was switched.

The operation control portion 406A executes generation of image data in the image reading portion 120A, printing of the image data in the image forming portion 140A and the like, based on a user's instruction via the operation panel 200A detected by the operation recognition portion 405A.

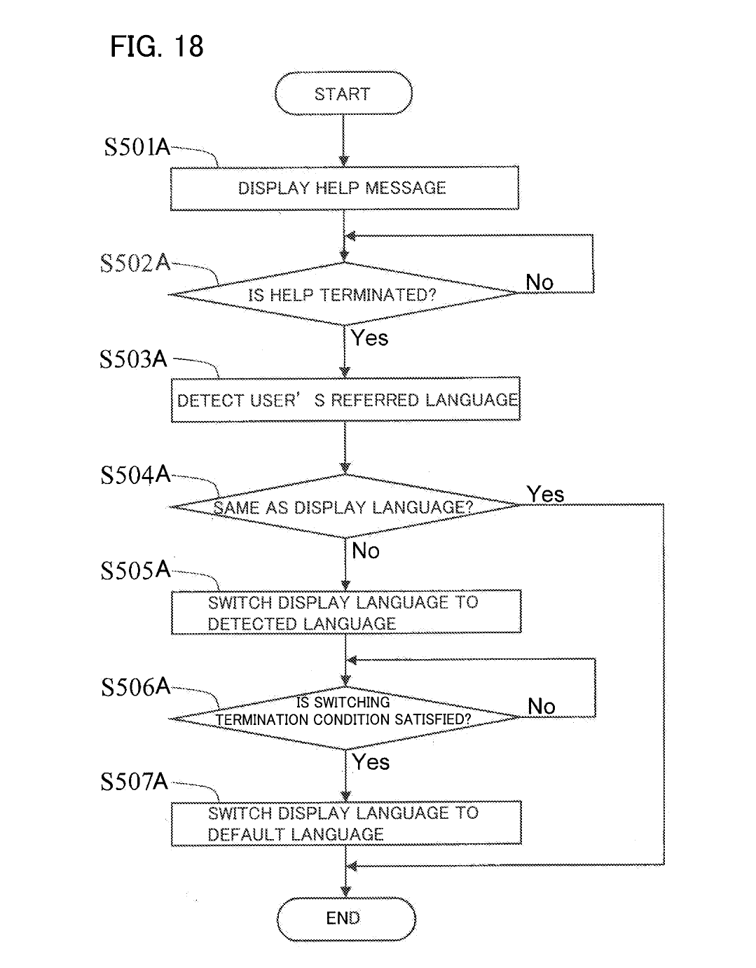

FIG. 18 is a diagram showing an example of a display language switching procedure executed by the operation device 400A included in the multi-function peripheral 100A.

The procedure is triggered by, for example, detection by the operation recognition portion 405A of pressing of the help key 213A.

Hereinafter, a case of the help key 213A being pressed, in a state in which a combine setup screen is displayed on the display 201A as a result of a user pressing a “Combine” button 207b in the operation screen shown in FIG. 2, is described.

First, the combine setup screen is described.

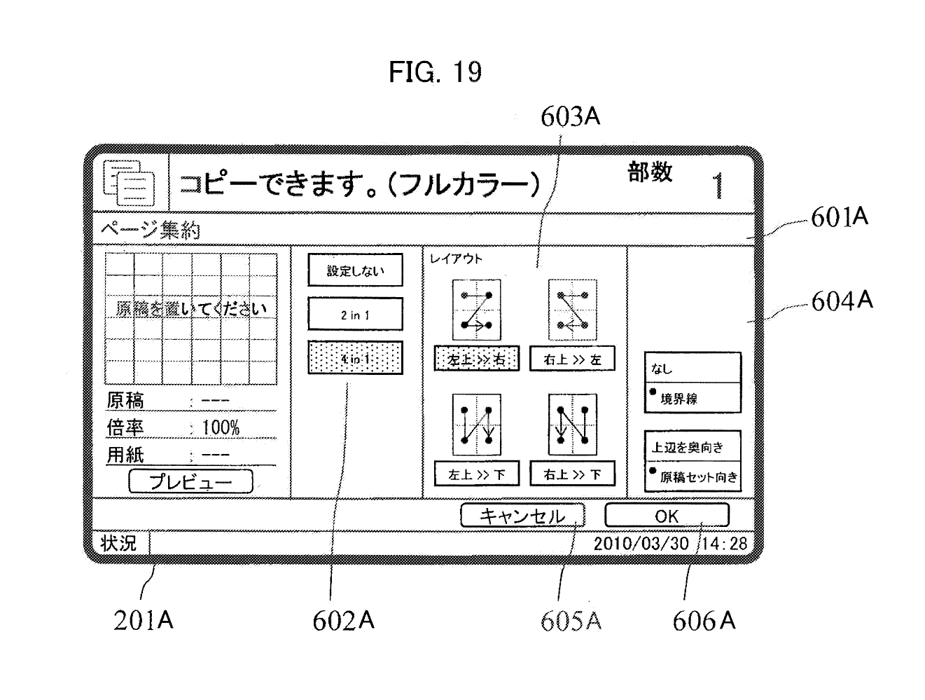

FIG. 19 is a diagram showing an example of the combine setup screen. In this example, the combine setup screen 601A includes: a combine type selection column 602A; a layout selection column 603A; an option selection column 604A; a Cancel button 605A used for canceling setup and displaying an initial operation screen shown in FIG. 2; and an OK button 606A to be selected upon completion of setup.

In the combine type selection column 602A, an “Off” button, a “2 in 1” button for combining 2 pages of original into one page, and a “4 in 1” button for combining 4 pages of original into one page are arranged for selecting combine types.

In the layout selection column 603A, a “Right then Down” button, a “Left then Down” button, a “Down then Right” button, and a “Down then Left” buttons are arranged for selecting layout of combined pages.

FIG. 19 shows the layout selection column 603A displayed in a case in which the “4 in 1” button is selected in the combine type selection column 602A.

In the option selection column 604A, a “Border Line” selection column for selecting presence/absence of border line, an “Original Orientation” selection column for selecting orientation of the original placed on the platen 103A or the original feeder 110A, are arranged.

When a user presses the help key 213A in a state in which the abovementioned combine setup screen 601A is displayed on the display 201A, the display control portion 404A reads the help message to be displayed from the message storage portion 401A and sequentially displays on the display 201A as described above (Step S501A).

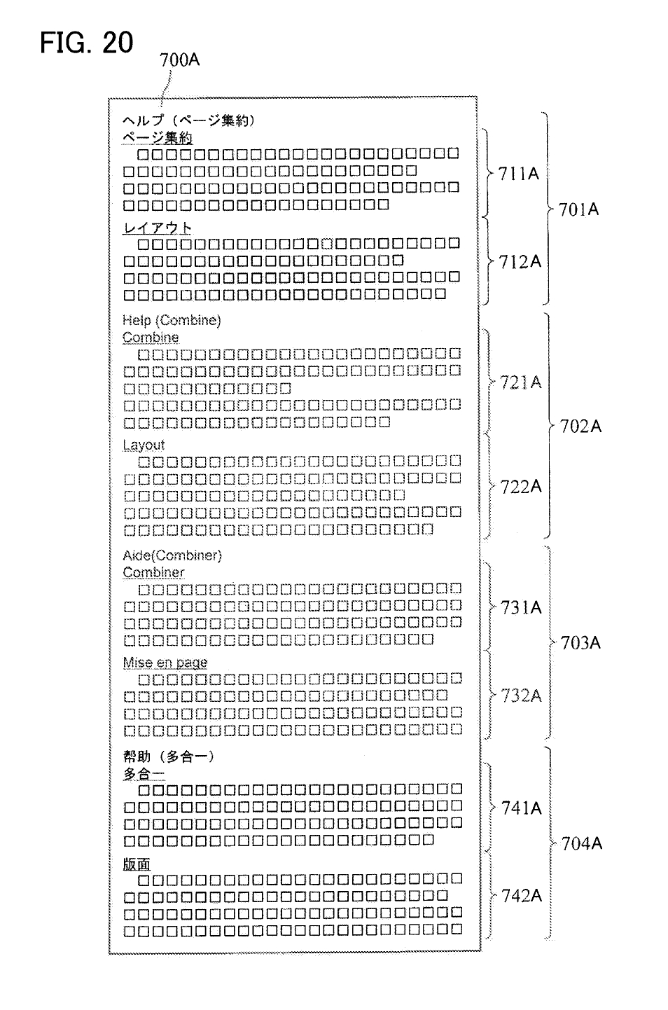

FIG. 20 is a diagram showing an example of the help message the display control portion 404A thus displays on the display 201A.

For the sake of description, a help message 700A shown here is composed only from message groups describing “Combine” and “Layout”, and messages for other items are omitted.

Although an example of using four languages is shown in FIG. 20, it is obvious that the number of languages can be accordingly selected.

The help message 700A includes: a message portion 701A expressed in Japanese, which is the default display language; a message portion 702A expressed in English, which is a second display language; a message portion 703A expressed in French, which is a third display language; and a message portion 704A expressed in Chinese, which is a fourth display language.

The message portions 701A to 704A include message portions 711A, 721A, 731A and 741A relating to the item “Combine” and message portions 712A, 722A, 732A and 742A relating to the item “Layout”, respectively.

The message portions 701A to 704A are arranged in an order of: the default display language; the second display language; the third display language; and the fourth display language, in a vertical direction, which is a scrolling direction (described later) of the message display screen, thereby composing the help message 700A.

Therefore, when a user scrolls the help message 700A in the message display screen, the message portions 701A to 704A expressed in these display languages are sequentially displayed.

The help message 700A can be stored in the message storage portion 401A as a single message.

However, the help message 700A is preferably generated from individual messages stored in the message storage portion 401A for each language and for each item, by combining these individual messages when the display control portion 404A displays the help message.

In the latter configuration, modification and addition of a message, and addition of a new display language can be easily made.

In addition, the display order of the second, third, and fourth display languages can be changed according to referred frequencies thereof.

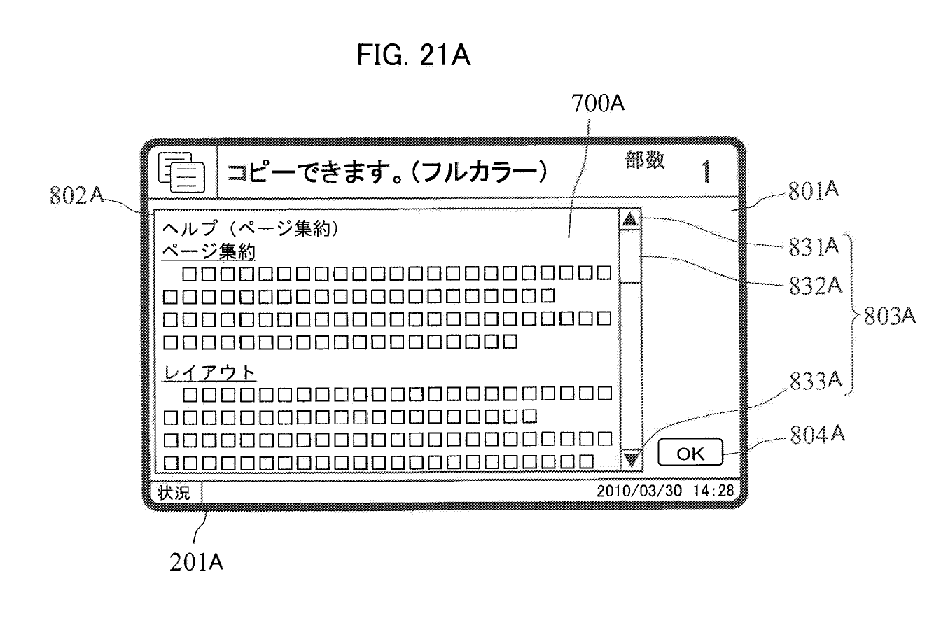

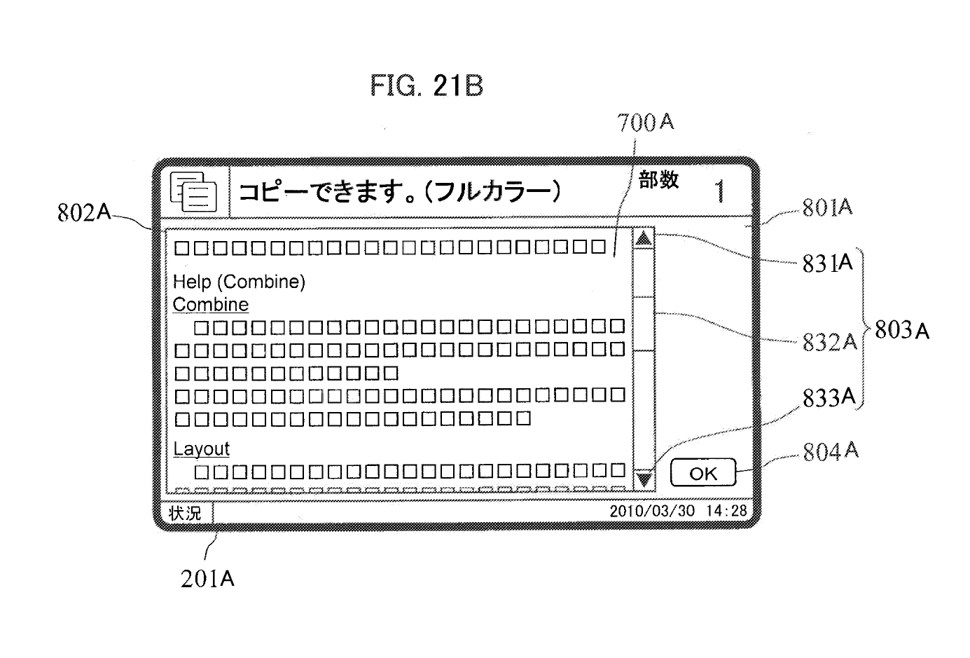

FIGS. 21A and 21B are diagrams showing an example of the message display screen that is displayed when a user presses the help key 213A in a state in which the combine setup screen 601A is displayed on the display 201A.

As shown in FIGS. 21A and 21B, the message display screen 801A includes: a message display column 802A that displays the help message; a scroll bar 803A provided in a right end of the message display column 802A; and an “OK” button 804A that is to be selected for closing the message display screen 801A and returning to the combine setup screen 601A.

The scroll bar 803A includes an upward scroll arrow 831A, a knob 832A, and a downward scroll arrow 833A.

As commonly known, the upward scroll arrow 831A is used to move the help message 700A displayed in the message display column 802A downward to show a region above the region displayed at that moment. The downward scroll arrow 833A is used to move the help message 700A displayed in the message display column 802A upward to show a region below the region displayed at that moment. A scroll size for the upward scroll arrow 831A and the downward scroll arrow 833A can be appropriately set to a specified number of lines, a page, and the like. The knob 832A is used for moving a displayed region and shows a position of the displayed region in the entire help message 700A and a proportion of the displayed region to the entire help message 700A.

FIG. 21A shows a state in which an uppermost part of the help message 700A is displayed in the message display column 802A.

FIG. 21B shows a state in which a lowermost line displayed in the message display column 802A of FIG. 21A is displayed as an uppermost line in the message display column 802A.

When a user presses the “OK” button 804A in the message display screen 801A, the language detection portion 402A detects the language of the message referred to by the user in the help message 700A displayed on the display 201A (Step S502AYes, S503A).

In response to an input from the operation recognition portion 405A indicating the pressing on the “OK” button 804A, the language detection portion 402A retrieves a help message display history from the display control portion 404A.

The language detection portion 402A detects the language of the message referred to the user based on the help message display history thus retrieved.

The help message display history is information representing a history of a display state (displayed region and display period) of the help message 700A in the message display column 802A, during a period from opening to closing of the message display screen 801A.

For example, in a case in which a help message of a single language (e.g. only one of the message portions 701A to 704A) is recorded in the help message display history as the message displayed upon closing of the message display screen 801A, the language detection portion 402A can detect the language as the language of the message referred to by the user.

On the contrary, in a case in which a help message of a plurality of languages is recorded in the help message display history as the message displayed upon closing of the message display screen 801A, the language detection portion 402A detects the language of the message referred to by the user from the help message display history, based on an areal proportion of these languages in the message display column 802A, a display period of these languages, and a scroll history.

For example, in the example of FIG. 21B, the message portion 701A in Japanese and the message portion 702A in English are displayed in the message display column 802A.

In this example, if an operation of quickly scrolling from the state of FIG. 21A to the state of FIG. 21B and then staying for a certain amount of time in the state of FIG. 21B is recorded in the help message display history, the language detection portion 402A can consider English, which is a language of a greater areal proportion, as the language of the message referred to by the user.

Such a determination can be made also by calculating a sum of products of a time period for which the message has stayed in the message display column 802A by an areal proportion thereof in the message display column 802A during the time period, for each language.

Alternatively, in a case in which downward scroll and stopping are repeatedly performed, a language in the uppermost position can be simply determined to be the language of the message referred to by the user.

The language detection portion 402A, which has thus determined the language of the message referred to by the user, inputs the referred language thus determined to the display language switching portion 403A.

After receiving the input, the display language switching portion 403A compares the display language of the operation screen displayed on the display 201A at that moment and the referred language thus input (Step S504A).

If the display language at that moment and the referred language are the same, the display language switching portion 403A do nothing and terminates the procedure (Step S504A, Yes).

If the display language at that moment and the referred language are different, the display language switching portion 403A switches the display language of the operation screen displayed on the display 201A to the referred language thus input (Step S504A, No, S505A).

Such language switching is realized by the display language switching portion 403A instructing the display control portion 404A to switch the display language to the referred language.

In the present embodiment, the display language switching portion 403A, having input the instruction to the display control portion 404A, monitors whether the preregistered display language switching termination condition is satisfied or not (Step S506A).

Here, a predetermined elapsed time period (for example, 10 minutes) since notification of a display language switching instruction is preregistered to the display language switching portion 403A as the display language switching termination condition.

Accordingly, the display language switching portion 403A monitors the elapsed time period since input of the instruction to the display control portion 404A, and switches the display language of the operation screen to the default display language (Japanese) when the elapsed time period reaches the predetermined value (Step S506A, Yes, S507A).

Such language switching is also realized by the display language switching portion 403A instructing the display control portion 404A to switch the display language to the default display language.

While the display language switching termination condition is not satisfied, the display language is maintained to be the referred language (Step S506A, No).

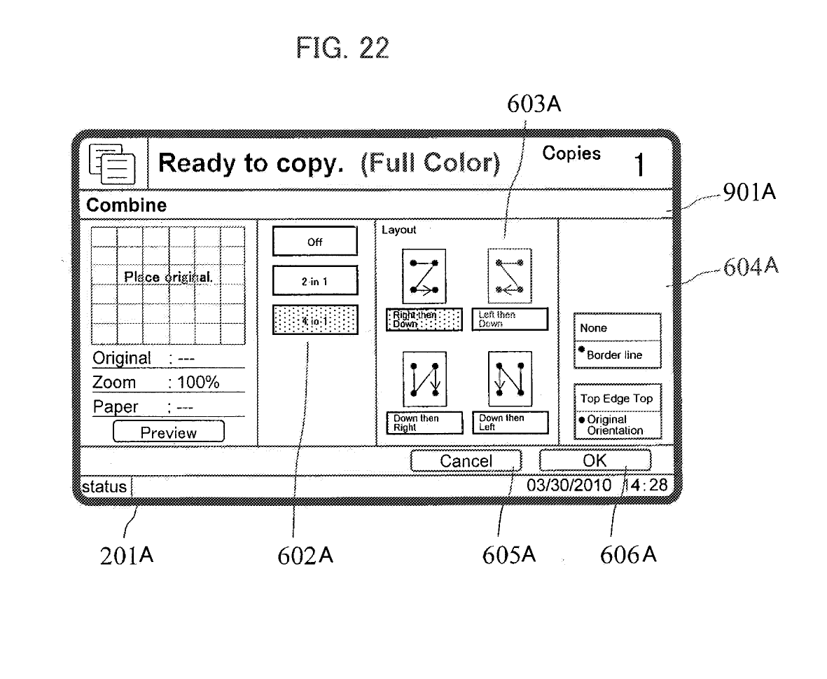

FIG. 22 is a diagram showing an example of the combine setup screen displayed on the display 201A in a case in which the referred language detected by the language detection portion 402A when a user closed the message display screen 801A is English.

In the example of FIG. 22, the combine type selection column 602A; the layout selection column 603A; the option selection column 604A; the Cancel button 605A; and the OK button 606A included in the combine setup screen 901A are all changed to English.

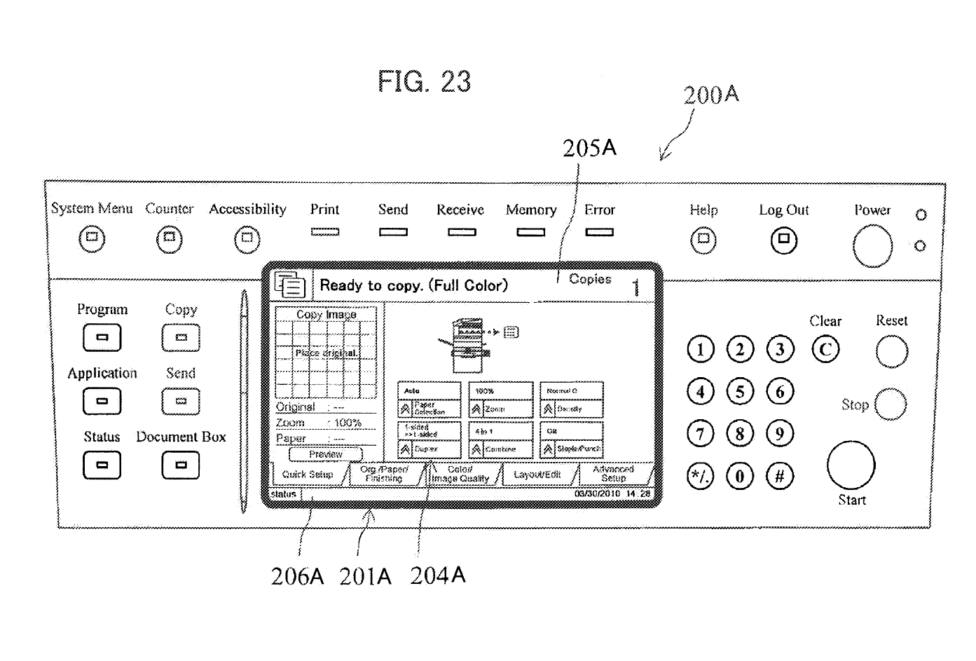

FIG. 23 is a diagram showing an example of an initial screen displayed on the display 201A in a case in which the user closes the combine setup screen 901A before the display language switching termination condition is satisfied.

In the example of FIG. 23, the button display portion 204A, the message display portion 205A, and the status display portion 206A displayed (disposed) in the operation screen are all changed to English.

As described above, in the multi-function peripheral 100A, when the user refers to the help message expressed in a language different from the display language, the display language of the operation screen is switched to the language of the help message.

In other words, when the user refers to a help message expressed in the user's familiar language in the help message in a plurality of languages, the display language of the operation screen is switched to and maintained in the language of the help message thus referred until the display language switching termination condition is satisfied.

Therefore, the help message can be easily understood by a user whose mother tongue is different from the display language.

In addition, even in a case of referring to the help message for using an unfamiliar function, with the display language of the operation screen being automatically changed to a user's familiar language, the user can smoothly use the function thereafter.

Furthermore, the display language is automatically switched back to the default display language when the display language switching termination condition is satisfied, confusion of other users can be avoided.

This configuration is even more preferable because no special operation by a user is required for switching languages.

Since there is no need of providing a language switching button as a hardware key or an on-screen software key, a configuration allowing easy addition of other display languages can be realized without lowering layout flexibility of the operation screen and the operation panel.

It should be noted that the abovementioned embodiment is not intended to limit a technical scope of the present invention and various modifications and applications can be made in addition to the above description within the scope of the present invention.

For example, in the above embodiment, the present invention has been described based on operations through the operation panel of the multi-function peripheral; however, operations can be made through an information processing terminal such as personal computer communicatively connected to the multi-function peripheral.

In this case, a function of the display 201A of the operation panel 200A as in the above embodiment is provided by a display means such as a display and an input means such as a keyboard provided in the information processing terminal.

In addition, in the flow chart shown in FIG. 18, the order of the steps can be changed within a scope of providing the similar effect.

For example, in the above embodiment, a configuration is employed in which the referred language is determined upon closing of the message display screen; however, the similar effect can be provided by determining the referred language continuously and performing the switching upon closing of the message display screen.

Furthermore, although the elapsed time period is used as the display language switching termination condition in the above description, for example in a case of the multi-function peripheral 100A having an authentication function that identifies users, logout of a user can also be used as the display language switching termination condition.

Alternatively, a predetermined amount of time of absence of operation of the operation panel by a user can also be used as the display language switching termination condition.

With such configurations, the abovementioned language switching can be applied to a certain user.

In addition, in the above embodiment, the present invention is concretized as a digital multi-function peripheral; however, the present invention is not limited thereto and can be applied to any electronic apparatus, for example image forming apparatuses such as printers, copy machines and the like.

Furthermore, the present invention can be applied to any operation device with a help function.

What is claimed is:

1. A help display device comprising: a display portion that displays a help message;
an operation portion that accepts an instruction for displaying a predetermined help message;
a message storage portion that stores identical help messages expressed in a plurality of languages;
a display order retention portion that retains a display order of the help messages expressed in a plurality of languages;
a message generation portion that, in a case where the operation portion accepts the instruction for displaying a help message on the display, reads the help message corresponding to the instruction from the message storage portion and generates a multilingual help message by arranging the help messages of each language thus read in the display order retained in the display order retention portion; and
a display control portion that displays the multilingual help message on the display portion by the message generation portion.

2. The help display device according to claim 1, further comprising a display order updating portion that updates the display order retained in the display order retention portion to a state in which a default language comes first in the display order.

3. The help display device according to claim 2, wherein the display order updating portion detects a referred frequency of the help message of each language in the multilingual help message and updates the display order retained in the display order retention portion based on the referred frequency thus detected.

4. An electronic apparatus comprising a help display device, the help display device including:
a display portion that displays a help message;
an operation portion that accepts an instruction for displaying a predetermined help message;
a message storage portion that stores identical help messages expressed in a plurality of languages;
a display order retention portion that retains a display order of the help messages expressed in a plurality of languages;
a message generation portion that, in a case where the operation portion accepts the instruction for displaying a help message on the display, reads the help message corresponding to the instruction from the message storage portion and generates a multilingual help message by arranging the help messages of each language thus read in the display order retained in the display order retention portion; and
a display control portion that displays the multilingual help message on the display portion by the message generation portion.

5. The electronic apparatus according to claim 4, further comprising a display order updating portion that updates the display order retained in the display order retention portion to a state in which a default language comes first in the display order.

6. The electronic apparatus according to claim 5, wherein the display order updating portion detects a referred frequency of the help message of each language in the multilingual help message and updates the display order retained in the display order retention portion based on the referred frequency thus detected.

7. An operation device comprising: a display portion;
an operation portion that accepts an instruction for displaying a predetermined help message;
a message storage portion that stores identical help messages expressed in a plurality of languages;
a display control portion that performs display in a predetermined display language and displays the help messages expressed in a plurality of languages on the display portion;
a language detection portion that detects the language of the help message referred to by a user in the help message expressed in a plurality of languages; and
a language switching portion that switches the display language displayed on the display portion to the language detected by the language detection portion and switches the display language displayed on the display portion from the language detected by the language detection portion to the predetermined display language if a preregistered display language switching termination condition is satisfied.

8. The operation device according to claim 7, wherein the display language switching termination condition is an elapsed time period since the language switching portion has switched the display language displayed on the display portion to the language detected by the language detection portion.

9. An electronic apparatus comprising an operation device, the operation device including:
a display portion;
an operation portion that accepts an instruction for displaying a predetermined help message;
a message storage portion that stores identical help messages expressed in a plurality of languages;
a display control portion that performs display in a predetermined display language and displays the help messages expressed in a plurality of languages on the display portion;
a language detection portion that detects the language of the help message referred to by a user in the help message expressed in a plurality of languages; and
a language switching portion that switches the display language displayed on the display portion to the language detected by the language detection portion and switches the display language displayed on the display portion from the language detected by the language detection portion to the predetermined display language if a preregistered display language switching termination condition is satisfied.

10. The electronic apparatus according to claim 9, wherein the display language switching termination condition is an elapsed time period since the language switching portion has switched the display language displayed on the display portion to the language detected by the language detection portion.
